(19) United States
(12) Patent Application Publication
(10) Pub. No.: US 2009/0211448 A1
(43) Pub. Date: Aug. 27, 2009

(54) Oxygen concentrator water separating system

(76) Inventor: MICHAEL S. MCCLAIN, Ortonville, MI (US)

Correspondence Address: DELPHI TECHNOLOGIES, INC., M/C 480-410-202, PO BOX 5052, TROY, MI, 48007, US

(21) Appl. No.: 12/070,894

(22) Filed: Feb. 21, 2008

(51) Int. Cl. B01D 53/14; B01D 53/02; B01D 53/22; B01D 19/00; B01D 53/047; B01D 53/24

(52) U.S. Cl. 95/211; 96/108; 96/10; 96/131; 95/130; 95/261; 96/111

(57) ABSTRACT

An apparatus for separating humidity from a pressurized feed gas is provided the apparatus having a housing; an intake path formed at a first end of the housing; a centrifugal device disposed within the housing; a sieve bed disposed within the housing; an outlet path formed at a second end of the housing; a purge path formed below the intake path; and a water sump zone located within the housing below the centrifugal device. The centrifugal device receives the feed gas from the intake path during a charge phase and directs the feed gas in a centrifugal pattern to cause water vapor in the feed gas to condense into water droplets on the inner wall. The water droplets are discharged from the housing through the purge path with an exhaust gas during a purge phase.

### BACKGROUND

Exemplary embodiments of the present invention relate to oxygen concentrators, and, more specifically, exemplary embodiments of the present invention relate to water separating systems for oxygen concentrators.

There is a need for home and ambulatory oxygen systems for use by patients. For patients exhibiting symptoms from certain diseases and lung disorders such as pulmonary fibrosis, sarcoidosis, or occupational lung disease, supplemental oxygen therapy is an increasingly beneficial and oftentimes required prescription to help the patients live normal and productive lives. For example, while not a cure for lung disease, prescriptive supplemental oxygen increases blood oxygenation, which reverses hypoxemia. Oxygen prescriptions can help prevent long-term effects of oxygen deficiency on organ systems, the heart, brain, and kidneys. Oxygen treatment is also prescribed for Chronic Obstructive Pulmonary Disease (COPD), heart disease, AIDS, asthma, and emphysema.

Currently, supplemental medical oxygen for therapy is provided to a patient from high pressure gas cylinders; cryogenic liquid in vacuum-insulated containers or thermos bottles commonly called “dewars”, and oxygen concentrators. Some patients require in-home oxygen only, while others require in-home as well as ambulatory oxygen depending on the prescription. The three systems are all used for in-home use. Oxygen concentrators in particular provide a special beneficial advantage in that they do not require the refilling of dewars or the exchange of empty cylinders, which contain only a finite amount of compressed oxygen gas or liquid oxygen that typically lasts only a few hours, with full ones. Oxygen concentrators produce oxygen concentrated air on a constant basis by filtering charged or compressed intake ambient air through a molecular sieve bed or pressure swing adsorption (PSA) system to separate or absorb nitrogen.

PSA is a technology used to separate some gas species from a mixture of gases under pressure according to the species' molecular characteristics and affinity for an adsorbent material. Special adsorptive materials are used as a molecular sieve to adsorb the target gas species, typically at high pressure. The process then swings to low pressure to desorb the adsorbent material. The use of two or more adsorbent beds can allow for a near-continuous production of the target gas, as well as pressure equalization, in which gas leaving beds being depressurized can be used to partially pressurize other beds to result in energy savings.

While effective at continual production of oxygen, oxygen concentrators do, however, have drawbacks. They tend to consume relatively large amounts of electricity, be relatively large and heavy, emit excessive heat, and be relatively noisy. Oxygen concentrators typically weigh between 35 and 55 pounds, which is generally too heavy to be easily transported for ambulatory use. As a result, many patients requiring the use of oxygen concentrators are tethered to the stationary machines and inhibited in their ability to lead an active life. While portable oxygen concentrators have been developed to provide patients with greater mobility, the currently commercially available portable concentrators do not necessarily provide patients with the ease of mobility that they desire.

In an attempt to reduce the physical packaging design to oxygen concentrators and provide patients with greater mobility, there has been a movement toward design of portable oxygen concentrators. The present designs, however, are limited in that they subject the oxygen production process to much harsher environmental conditions. In particular, the environmental condition that is most important to such systems is that of high humidity, as water vapor and water droplets that form in the intake ambient air operate to deactivate the primary adsorptive material for concentrating oxygen, which is zeolite. This has the effect of lowering the efficiency of the oxygen concentration process, requiring an amount of energy to compensate for the inefficiency that is impractical for sustained battery operation, or requiring an amount of zeolite that is prohibitively costly or excessively weighty.

Accordingly, it is desirable to provide a method and apparatus for oxygen concentration systems that can effectively negate these inefficiencies and thereby allow the systems to maintain the desired flow rate and concentration needed to achieve a smaller, lightweight overall machine package capable of battery operation.

### SUMMARY

Exemplary embodiments of the present invention are related to an apparatus for separating humidity from a pressurized feed gas. The apparatus comprises a housing having a first end, a second end, and an inner wall; an intake path formed at the first end of the housing for delivering the feed gas into the housing during a charge phase; a centrifugal device disposed within the housing proximate to the intake path; a sieve bed disposed within the housing between the first end and the second end; an outlet path formed at the second end of the housing; a purge path formed at the first end of the housing below the intake path; and a water sump zone located within the housing below the centrifugal device. The feed gas comprises a product gas, an exhaust gas, and water vapor. The centrifugal device is positioned to receive the feed gas from the intake path during the charge phase and is configured to direct the feed gas toward an inner wall of the housing in a centrifugal pattern to cause the water vapor in the feed gas to separate from the feed gas and to condense into water droplets on the inner wall. The centrifugal device is further configured to pass the feed gas in a first direction from the first end of the housing toward the second end. The sieve bed comprises an adsorbent material for separating the exhaust gas in the feed gas from the product gas. The sieve bed is configured to receive the feed gas passed from the centrifugal device during the charge phase, to adsorb the exhaust gas from the feed gas, and to pass the product gas from the feed gas in the first direction toward the second end. The outlet path is configured to receive the product gas from the sieve bed and to deliver the product gas out of the housing during the charge phase. The outlet path is further configured to deliver the product gas into the housing and to pass the product gas in a second direction from the second end of the housing toward the first end during a purge phase. The sieve bed is further configured to receive the product gas from the outlet path and to pass the product gas in the second direction toward the second end during the purge phase. The product gas acts to evacuate the exhaust gas adsorbed by the sieve bed as it flows through the sieve bed in the second direction during the purge phase. The purge path is configured to receive the product gas and the exhaust gas flowing in the second direction from the sieve bed and to discharge the product gas and the exhaust gas from the housing during the purge phase. The water sump zone is configured to collect the water droplets condensed against the inner wall. The water sump zone is in fluid communication with the purge path such that the water droplets in the water sump zone are discharged from the housing through the purge path with the exhaust gas and the product gas during the purge phase. The housing is configured to alternately receive the feed gas through the intake path during the charge phase and discharge the exhaust gas through the purge path during the purge phase for charge/purge durations.

Exemplary embodiments of the present invention are also related to a gas concentration apparatus. The apparatus comprises a first housing having a first end, a second end, and an inner wall; and a second housing having a first end, a second end, and an inner wall. The first housing is configured to alternately receive a feed gas from a first intake path formed at the first end of the first housing during a charge phase and to discharge an exhaust gas through a first purge path formed at the first end of the first housing below the first intake path during a purge phase. The second housing is configured to alternately receive the feed gas from a second intake path formed at the first end of the second housing during a charge phase and to discharge the exhaust gas through a second purge path formed at the first end of the second housing below the second intake path during a purge phase. The feed gas comprises a product gas, the exhaust gas, and water vapor. The apparatus further comprises a first centrifugal device disposed within the first housing proximate to the first intake path, a first sieve bed disposed within the first housing between the first and second ends of the first housing, a first outlet path formed at the second end of the first housing; and a first water sump zone located within the first housing below the first centrifugal device. The first centrifugal device is positioned to receive the feed gas from the first intake path during the charge phase and is configured to direct the feed gas toward an inner wall of the first housing in a centrifugal pattern to cause the water vapor in the feed gas to separate from the feed gas and to condense into water droplets on the inner wall of the first housing. The first centrifugal device is further configured to pass the feed gas in a first direction from the first end of the first housing toward the second end. The first sieve bed comprises an adsorbent material for separating the exhaust gas in the feed gas from the product gas. The first sieve bed is configured to receive the feed gas passed from the first centrifugal device during the charge phase, adsorb the exhaust gas from the feed gas, and pass the product gas from the feed gas in the first direction toward the second end of the first housing. The first outlet path is configured to receive the product gas from the first sieve bed and deliver the product gas out of the first housing during the charge phase. The first outlet path is further configured to deliver the product gas into the first housing and to pass the product gas in a second direction from the second end of the first housing toward the first end during a purge phase. The first sieve bed is configured to receive the product gas from the outlet path and to pass the product gas in the second direction toward the second end of the first housing during the purge phase. The product gas acts to evacuate the exhaust gas adsorbed by the first sieve bed as it flows through the first sieve bed in the second direction during the purge phase. The first purge path is configured to receive the product gas and the exhaust gas flowing in the second direction from the first sieve bed and to discharge the product gas and the exhaust gas from the first housing during the purge phase. The first water sump zone is configured to collect the water droplets condensed against the inner wall of the first housing. The first water sump zone is in fluid communication with the first purge path such that the water droplets in the first water sump zone are discharged from the first housing through the first purge path with the exhaust gas and the product gas during the purge phase. The apparatus further comprises a second centrifugal device disposed within the second housing proximate to the second intake path, a second sieve bed disposed within the second housing between the first and second ends of the second housing, a second outlet path formed at the second end of the second housing; and a second water sump zone located within the second housing below the second centrifugal device. The second centrifugal device is positioned to receive the feed gas from the second intake path during the charge phase and is configured to direct the feed gas toward an inner wall of the second housing in a centrifugal pattern to cause the water vapor in the feed gas to separate from the feed gas and to condense into water droplets on the inner wall of the second housing. The second centrifugal device is further configured to pass the feed gas in a third direction from the first end of the second housing toward the second end. The second sieve bed comprises the adsorbent material for separating the exhaust gas in the feed gas from the product gas. The second sieve bed is configured to receive the feed gas passed from the second centrifugal device during the charge phase, adsorb the exhaust gas from the feed gas, and pass the product gas from the feed gas in the third direction toward the second end of the second housing. The second outlet path is configured to receive the product gas from the second sieve bed and deliver the product gas out of the second housing during the charge phase. The second outlet path is further configured to deliver the product gas into the second housing and to pass the product gas in a fourth direction from the second end of the second housing toward the first end during a purge phase. The second sieve bed is configured to receive the product gas from the outlet path and to pass the product gas in the fourth direction toward the second end of the second housing during the purge phase. The product gas acts to evacuate the exhaust gas adsorbed by the second sieve bed as it flows through the second sieve bed in the fourth direction during the purge phase. The second purge path is configured to receive the product gas and the exhaust gas flowing in the fourth direction from the second sieve bed and to discharge the product gas and the exhaust gas from the second housing during the purge phase. The second water sump zone is configured to collect the water droplets condensed against the inner wall of the second housing. The second water sump zone is in fluid communication with the second purge path such that the water droplets in the second water sump zone are discharged from the second housing through the second purge path with the exhaust gas and the product gas during the purge phase. The apparatus further comprises a compressor configured to receive the feed gas and supply the feed gas under pressure to the first and second intake paths; a set of valves disposed between the compressor and the first ends of the first and second housings; and a controller coupled to the set of valves and configured to selectively open and close the valves to alternately charge the first housing with the feed gas while the exhaust gas is purged from the second housing and charge the second housing with the feed gas while the exhaust gas is purged from the second housing for the charge/purge durations.

Exemplary embodiments of the present invention are also related to a method for separating water particles from a pressurized gas mixture. The method comprises receiving a feed gas from an intake path of a housing for a sieve bed, the feed gas comprising a product gas, an exhaust gas, and water vapor, the sieve bed comprising an adsorbent material for separating the exhaust gas in the feed gas from the product gas; directing the feed gas to move in a centrifugal pattern such that the water vapor in the feed gas is forced radially outward against an inner wall of the housing; permitting the water vapor forced against the inner wall to condense into water droplets; directing the feed gas through the sieve bed such that the adsorbent material adsorbs the exhaust gas in the feed gas; collecting the water droplets condensed against the inner wall in a water sump zone located within the housing; and discharging the exhaust gas adsorbed by the absorbent material and water droplets collected in the water sump zone from the housing through a purge path.

The above-described and other features of the present disclosure will be appreciated and understood by those skilled in the art from the following detailed description, drawings, and appended claims.

### BRIEF DESCRIPTION OF THE DRAWINGS

FIG. 1 is a block diagram of a portable oxygen concentration system constructed in accordance with an exemplary embodiment of the present invention;

FIG. 2 is a block diagram of an oxygen concentrator unit in accordance with an exemplary embodiment of the present invention;

FIG. 3 is a cross-sectional view of a sieve bed employing a water separating mechanism in accordance with an exemplary embodiment of the present invention;

FIG. 4 is an exploded view of a water separating mechanism in accordance with an exemplary embodiment of the present invention; and

FIG. 5 is a cross-sectional view of a water separating mechanism in accordance with an exemplary embodiment of the present invention.

### DESCRIPTION OF EXEMPLARY EMBODIMENTS

Exemplary embodiments of the present invention can be implemented to perform separation of water vapor and/or particles from the charged or compressed intake ambient air of an oxygen concentrator apparatus and purge the separated moisture from the oxygen concentrator apparatus through the apparatus's normal vent cycle. Exemplary embodiments can be implemented to provide for separation of moisture from the intake ambient air of any molecular sieve bed oxygen concentration system design, such as those implementing a pressure swing absorption (PSA) process, a vacuum pressure swing adsorption (VPSA) process, a rapid PSA process, a very rapid PSA process, or any other like process.

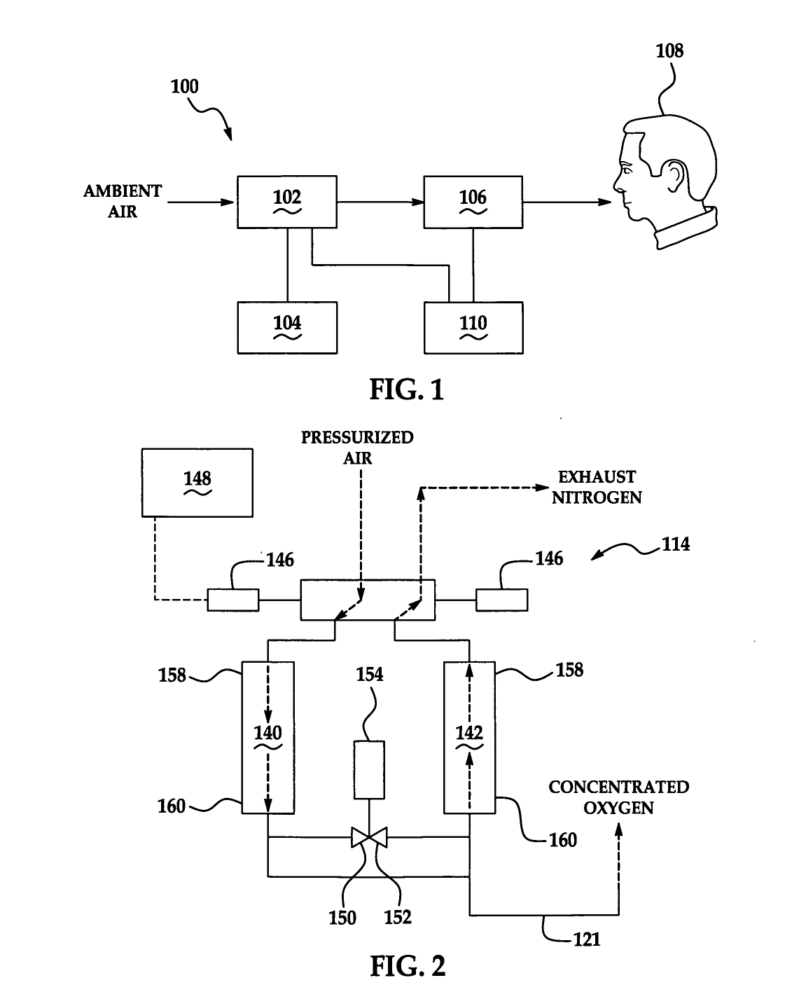

With reference to FIG. 1, an oxygen concentration system, indicated generally by reference numeral 100, constructed in accordance with an exemplary embodiment of the present invention is illustrated and will now be described. Exemplary oxygen concentration system 100 is used for fractionating at least one component, namely nitrogen, from a gaseous mixture, generally but not necessarily ambient air, by PSA to produce a product gas. Ambient air contains approximately 21 percent oxygen, 78 percent nitrogen, and 1 percent argon. System 100 is also used for delivering the product gas at specific and variable intervals upon demand by a user 108. System 100 is capable of pulsed or continuous delivery of oxygen at substantially higher concentrations that that of ambient air.

In the present exemplary embodiment, oxygen concentration system 100 includes an air separation device 102 such as an oxygen gas generator that separates concentrated oxygen gas from ambient air, an energy source 104 such as a plug configured to allow the system to be powered from a DC power source and/or an AC power source, a rechargeable battery, a battery pack, or a fuel cell that powers at least a portion of air separation device 102, one or more output sensors 106 used to sense one or more conditions of user 108, the environment, etc., such as flow rate, oxygen concentration level, etc., to determine the oxygen output needed by the user or required from system 100, and a control unit 110 linked to output sensor(s) 106, air separation device 102, and energy source 104 to control the operation of air separation device 102 in response to the one or more conditions sensed by output sensor(s) 106. Control unit 110, for instance, can regulate air separation device 102 to control the flow rate of oxygen gas to user 108 based on signals representative of the activity level of the user produced by sensor(s) 106. For example, if the output sensor(s) 106 indicates that user 108 has gone from an inactive state to an active state, control unit 110 may cause air separation device 102 to increase the flow rate of oxygen gas to user 108. If output sensor(s) 106 indicates that user 108 has gone from an active state to an inactive state, control unit 110 may cause air separation device 102 to reduce the flow rate of oxygen gas to user 108.

In exemplary embodiments, control unit 110 may take any well-known form in the art and includes a central microprocessor or CPU in communication with the components of the system described herein via one or more interfaces, controllers, or other electrical circuit elements for controlling and managing the system. System 100 may include a user interface as part of or coupled to control unit 110 for allowing the user, provider, doctor, etc. to enter information such as prescription oxygen level, flow rate, activity level, etc., to control system 100.

In alternative exemplary embodiments, oxygen concentration system 100 may not include output sensor(s) 106 coupled to control unit 110. In these embodiments, the conditions of system 100 may be constant for the system or may be manually controllable. For example, system 100 may include a user interface that allows a user, provider, doctor, etc. to enter information to control the oxygen output of system 100.

In exemplary embodiments, air separation device 102 can include, generally, a pump such as a compressor and an oxygen concentrator, which may be integrated within the air separation device. During operation of system 100, ambient air may be drawn through an inlet muffler by the compressor. In a manner that is described in greater detail below, the oxygen concentrator separates oxygen gas from the intake air for eventual delivery to user 108. Gas can ultimately be delivered to user 108 using an oxygen delivery tube, which can be a polymer tube or similar oxidation resistant structure that extends to the nose, mouth, or other port into the upper airway of the user.

In exemplary embodiments, the compressor may be driven by a motor that runs off of electrical current supplied by energy source 104 to deliver the intake air under pressure to the oxygen concentrator. In non-limiting exemplary embodiments, compressor 112 can utilize rotary vane, linear piston with wrist pin, linear piston without wrist pin, nutating disc, scroll, rolling piston, diaphragm pumps, and/or acoustic compressor technology.

In exemplary embodiments, the compressor can be configured to run at a variety of speeds. In exemplary embodiments, a variable-speed controller (VSC) or compressor motor speed controller may be integral with or separate from control unit 110 and can be coupled to the motor for conserving electricity consumption. The amount of oxygen gas supplied to user 108 can thereby be controlled by controlling the speed of the motor via the variable-speed controller. In exemplary embodiments, in addition or alternatively to the variable-speed controller, the supply of oxygen gas may be controlled by a supply valve located in a supply line between air separation device 102 and user 108. The speed of the compressor may be varied, for example, according to the activity level of the user, metabolic condition of the user, environmental condition, or other condition indicative of the oxygen needs of the user as determined through output sensor(s) 106.

With reference now to FIG. 2, an exemplary embodiment of an oxygen concentrator 114 in accordance with the present invention is illustrated and will now be described. Concentrator 114 has internal functions based around two sieve beds 140, 142 each having an air inlet/outlet end 158 and an oxygen inlet/outlet end 160. Each sieve bed is filled with a molecular sieve containing tiny pores of zeolite material, which is used as an adsorbent for nitrogen. Zeolite consists of molecular sized polyhedral cages. Oxygen and nitrogen molecules (for example) can access the inside of these cages through holes in the crystalline structure, which contains cations. Gas adsorption occurs when molecules are attached to these cations through electrostatic forces. Nitrogen molecules bind stronger to the zeolite cations than oxygen molecules. As a result, if a mixture of nitrogen and oxygen, such as found in atmospheric air, is pressurized into a sieve bed full of zeolite particles, nitrogen will adsorb into the zeolite particles more readily than oxygen. There will be a higher concentration of oxygen in the empty space between the zeolite particles than there was in the original gas mixture.

It should be noted that the present exemplary embodiment is non-limiting and that exemplary embodiments of the present invention can be incorporated within any suitable oxygen concentrator or air separation configuration or structure, including oxygen those employing a system that incorporates more than two sieve beds. In exemplary embodiments, concentrator 114 may implement a PSA process, a VPSA process, a rapid PSA process, a very rapid PSA process, etc. Furthermore, the use of zeolite herein is intended to be exemplary, and any other suitable adsorbent, whether a particular type of zeolite or other adsorbent, can be used in exemplary embodiments.

In the present exemplary embodiment, during operation, pressurized intake air is delivered to oxygen concentrator 114 by a compressor 112 as described above. Oxygen concentrator directs the pressurized airflow through one of sieve beds 140, 142, where the zeolite material, which strongly attracts nitrogen molecules while allowing oxygen molecules to pass through when under pressure, selectively adsorbs the nitrogen in the intake air. The nitrogen that is left adsorbed in the zeolite material must then be removed. One approach that can be utilized in exemplary embodiments for removing the nitrogen from the chamber is to blow oxygen enriched gas across the adsorbent material from oxygen inlet/outlet end 160 of the sieve bed to air inlet/outlet end 158. This counter-flow pushes nitrogen gas, as a wave, to air inlet/outlet end 158 of the sieve bed for venting to the atmosphere. In alternative exemplary embodiments, the nitrogen can be removed from the sieve bed by evacuating the sieve bed with a vacuum pump, which may be integrated with the compressor and driven by the motor, to improve the recovery and productivity of oxygen concentrator 114. The exhaust gas may oxygen concentrator 114 through an exhaust muffler.

In exemplary embodiments in which a PSA process is implemented, concentrator 114 may include a rotating valve or non-rotating valve mechanism to control air flow through multiple sieve beds therein. The valve mechanism may be selectively opened and closed to provide flow paths (for example, from the compressor to air intake paths of the sieve beds and/or from the sieve beds to air purge paths), and can comprise any suitable valve mechanism that allows for each sieve bed to be pressurized and/or exhausted independently of the other. In the present exemplary embodiment, the airflow is directed by a four-way solenoid valve mechanism 146, which is controlled by an electronic control unit 148. Once the intake air has passed through the one sieve bed, the nitrogen and most other impurities have been removed, and essentially all that remains is concentrated oxygen with trace amounts of inert argon. The residual concentrated oxygen can then flow through a pressure-reducing orifice 150, and then through a supply line 121 from concentrator 114 for eventual delivery to a user, completing one cycle of the oxygen concentrator.

In the present exemplary embodiment, during each cycle of concentrator 114, while one of sieve beds 140, 142 is pressurizing, pressure in the other sieve bed is reduced to approximately zero to allow the zeolite material to purge its adsorbed nitrogen into the atmosphere through, for example, an exhaust muffler. Then, to regenerate the purged zeolite material, this other sieve bed can, for example, be subjected to a pressure change or brought under heat from a vacuum generator to regenerate the zeolite. The flow of concentrated oxygen from product mix tank 144 is then split into two streams. The smaller stream is routed through supply line 121 from concentrator 114 for eventual delivery at the point of use to a user. The larger stream of concentrated oxygen is diverted through another pressure-reducing orifice 152 and flows through the sieve bed being purged. When this is complete, the cycle reverses (for example, every five to ten seconds), and the newly regenerated sieve bed pressurizes and produces oxygen while the other sieve bed is purged and regenerated. When the cycle is reversed, four-way valve 146 shuts off all flow into the beds momentarily while a crossover valve 154 opens to equalize the pressure between the two beds. In exemplary embodiments, the valves of valve mechanism 146 can be opened for desired durations at desired frequencies, which may be varied by control unit 148, thereby providing for pulse delivery. Alternatively, control unit 148 may maintain open valves to provide for continuous delivery, rather than pulsed delivery.

In this manner, each of sieve beds 140, 142 is alternately adsorbing and purging, and during each cycle, intake air is flowed through one sieve bed where the nitrogen molecules are captured by the zeolite, while the other sieve bed is vented off to ambient atmospheric pressure to allow the captured nitrogen to dissipate. Oxygen concentrator 114 is thereby able to produce a pulsed or continuous supply of concentrated oxygen. In exemplary embodiments, oxygen concentrator 114 can produce a pulsed continuous supply at a flow rate of up to approximately five liters per minute (LPM) at concentrations anywhere from 50 to 95 percent.

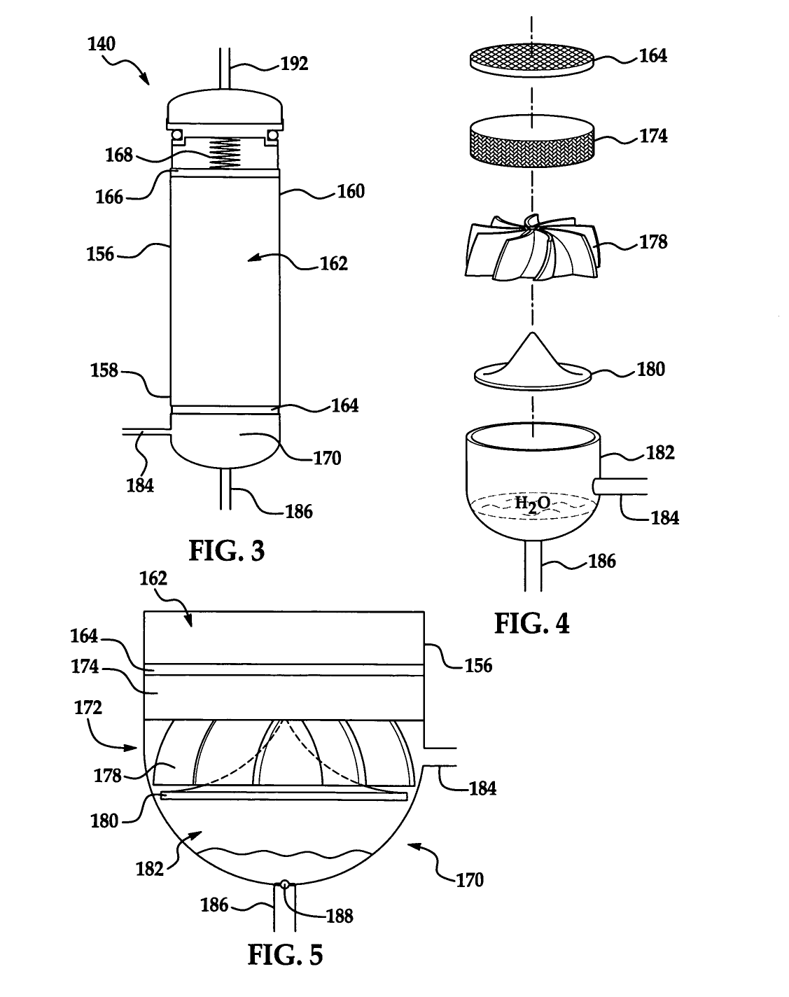

It should be appreciated that exemplary embodiments of the present invention are not limited by the above-described exemplary embodiment. Any other suitable configurations and/or components may be provided in exemplary embodiments for delivering oxygen to the user, rather than oxygen concentrator 114 and the components attached thereto described above. In addition, although the components attached thereto are described above in a particular sequence (relative to gas flow through oxygen concentrator 114), the sequence of these components may be changed as desired in exemplary embodiments. With reference now to FIG. 3, an exemplary embodiment of sieve bed 140 in accordance with the present invention is illustrated and will now be described. It should be noted that, in exemplary embodiments, each sieve beds in suitable oxygen concentrator configurations employing a plurality of sieve beds can be constructed in a similar fashion to sieve bed 140. Sieve bed 140 generally includes an outer casing 156 that can, for example, be in the shape of an elongate hollow cylinder. Casing 156 has a first or air inlet/outlet end 158 and a second or oxygen inlet/outlet end 160. More particularly, first end 158 includes an air intake path 184 for receiving pressurized air from compressor 112 and an air purge path 186 for purging exhaust gas through exhaust muffler 126. Casing 156 may be formed from a substantially rigid material such as plastic (for example, acrylonitrile butadiene styrene (“ABS”), polycarbonate, and the like), metal, (fore example, aluminum), or composite materials. Although casing 156 is shown having a round cylindrical shape in the present exemplary embodiment, it will be appreciated that in alternative exemplary embodiments, the casing may have other desired shapes, which may be determined based upon spatial, performance, structural, and/or other criteria. For example, casing 156 may have an elliptical, square, rectangular, or other regular or irregular polygonal shaped cross-section.

Casing 156 may be at least partially filled with filtration media or sieve material 162 to provide the ability of adsorb nitrogen from pressurized air delivered into sieve bed 140. Sieve material 162 may include one or more known materials capable of adsorbing nitrogen from pressurized ambient air, thereby allowing oxygen to be bled off or otherwise evacuated from the sieve bed 140. Exemplary sieve materials that may be used include synthetic zeolite, LiX, and the like, such as UOP Oxysiv 5, 5A, Oxysiv MDX, Zeox OII, Zeochem Z12-07, or Zeochem Z10-06.

In the present exemplary embodiment, to hold sieve material 162 within casing 156, sieve bed 140 includes lower and upper discs or diffuser plates 164, 166 respectively proximate to first and second ends 158, 160 of the casing. Diffuser plates 164, 166 may be spaced apart from one another to define a desired volume within casing 156 that may be filled with sieve material 162, and the diffuser plates can thereby retain the sieve material within the casing. For example, the desired volume may be between about 50 and 600 cubic centimeters. Generally, sieve bed 140 may be filled such that there are no substantial voids in sieve material 162 (that is, such that the sieve material is substantially packed between the diffuser plates 164, 166).

In exemplary embodiments, diffuser plates 164, 166 may include one or more openings or pores (not shown) to allow airflow therethrough. The porosity of diffuser plates 164, 166 may be substantially uniform across the cross-section of sieve bed 140 to ensure that flow into and/or out of the sieve bed is substantially evenly distributed across the area of the first and second ends 158, 160. Alternatively, the porosity of diffuser plates 164, 166 may be varied in a desired pattern, or only a portion of the diffuser plates may be porous. In yet another alternative, diffuser plates 164, 166 may have a solid wall and may include one or more openings therethrough in a desired pattern. Diffuser plates 164, 166 may be formed from sintered plastic to thereby providing pores within the plastic material that are smaller than the grain size of sieve material 162 that allow airflow through the diffuser plates. Alternatively, diffuser plates 164, 166 may be formed from plastic, metal, fabric, or composite materials having multiple holes or pores formed therethrough, and the holes may be created when diffuser plates 164, 166 are formed by molding the diffuser plates and holes simultaneously. For example, diffuser plates 164, 166 may comprise a fine mesh screen or fabric material. In another alternative, diffuser plates 164, 166 may be formed as solid panels cut from stock, molded, etc., and the holes may be created through the panels by drilling, laser cutting, and the like.

In the present exemplary embodiment, lower diffuser plate 164 is fixed to first end 158 of casing 156 by one or more cooperating connectors or fasteners (not shown), adhesives, sonic welding, and the like, and thereby held substantially stationary. Upper diffuser plate 166 may be disposed adjacent second end 160, yet movable within the casing 156. For example, as shown in FIG. 3, upper diffuser plate 166 may be biased towards lower diffuser plate 164 by a spring or other biasing mechanism 168, which may compress sieve material 162 between the diffuser plates. In this fashion, if sieve material 162 settles or somehow escapes from sieve bed 140, upper diffuser plate 166 may automatically move upwardly towards lower diff-user plate 164 to maintain sieve material 162 under a desired compression. This compression can prevent sieve material 162 from moving into other areas of oxygen concentrator 114.

Generally, to generate concentrated oxygen, an oxygen concentrator is operated such that the sieve beds are alternatively “charged” and “purged”, as described above. When a sieve bed is being charged or pressurized, compressed ambient air is delivered from the compressor into the air inlet/outlet end of the sieve bed, causing the sieve material to adsorb more nitrogen than oxygen as the sieve bed is pressurized. While the nitrogen is substantially adsorbed by the sieve material, oxygen escapes through the oxygen inlet/outlet end of the sieve bed, where it may be stored in a reservoir and/or be delivered to the user. Once the pressure within the sieve bed reaches a predetermined limit (or after a predetermined time), the sieve bed may then be purged or exhausted, that is, the air inlet/outlet end may be exposed to ambient pressure. This causes the compressed nitrogen within the sieve bed to escape through the air inlet/outlet end. In oxygen concentrators that employ sieve beds utilizing sieve material, such as those described in relation to exemplary embodiments herein, an issue that arises is that the pressurized intake air that is directed through the sieve beds can have a high water content. This issue arises because sieve material generally absorbs water in the intake air, which may cause some sieve material to deteriorate and/or have its ability to adsorb nitrogen be deactivated.

In the present exemplary embodiment, sieve bed 140 is provided with an integrated water separating mechanism 170 for separating water from a gas mixture (for example, pressurized ambient air). Water separating mechanism 170 is integrated at first end 158 with air intake path 184 for receiving pressurized air from compressor 112 and air purge path 186 for purging exhaust gas through exhaust muffler 126. Water separating mechanism 170 is configured to separate water vapor from the pressurized intake air received through air intake path 184 during the adsorbing portion of each cycle for sieve bed 140 and then purge the separated water vapor along with captured nitrogen during the purging portion of each cycle using air purge path 186 in the same manner as described above for venting the captured nitrogen.

With reference now to FIGS. 4 and 5, an exemplary embodiment of water separation mechanism 170 in accordance with the present invention is illustrated and will now be described. Water separation mechanism 170 generally includes a mechanical condenser or centrifuge 172, a coalescing filter 174, a water sump zone 182 disposed therein, an air purge path 186. As illustrated in FIG. 3, water separation mechanism 170 is disposed within casing 156 proximate first end 158 and below lower diffuser plate 164 so as to separate water vapor from the pressurized intake air prior to delivery of the intake air to sieve material 162, thereby preventing the water vapor in the intake from substantially impacting the sieve material's durability and/or ability to adsorb nitrogen. In exemplary embodiments, the components of water separating mechanism 170 can be within casing 156 using one or more cooperating connectors or fasteners (not shown), adhesives, sonic welding, and the like, and thereby held substantially stationary.

Mechanical condenser 172 includes of an air deflector 178 and an air baffle 180. During the adsorbing portion of each cycle for sieve bed 140, humid, pressurized intake air enters first end 158 of casing 156 through air intake path 184 and is directed to flow through mechanical condenser 170. The intake air then encounters air deflector 178, which can comprise a molded or formed propeller mechanism such as a rotor that causes the humid air to spin or move in a swirling or centrifugal motion. In exemplary embodiments, air deflector 178 may be driven by a motor, the force of the intake air, or the air deflector may remain stationary. The centripetal acceleration initiated by air deflector 178 operates to separate substances of greater and lesser density, and thereby has the effect of centrifugally flinging and impounding water vapor in the intake air radially outwardly and onto the inside surface of casing 156, where the water vapor accumulates and forms as condensed water droplets. The condensed water droplets that are formed on the inside surface of casing 156 will then encounter gravitational forces that cause the droplets run down the inside surface of casing 156 past air baffle 180 and gather or collect within water sump zone 182, which can comprise substantially hemispherical container such as one having a bowl-shape and can be made of a heat-resistant plastic such as, for example, polycarbonate. Water sump zone 182 is positioned at a lower elevation relative to air intake path 184 so as to substantially prevent collected water from reentering the flow path of the intake air. Air baffle 180 is configured with a conical shape to shed water droplets to the outside wall, as well as to prevent the intake air that is flowing through sieve bed 140 from agitating the collected water droplets in water sump zone 182 by substantially restricting airflow to the water sump zone. In exemplary embodiments, the inner surface of casing 156 can include a plurality of grooves, tracts, or channels configured to utilize the surface tension properties of water to direct the water droplets condensed against the inner surface toward water sump zone 182. This can be advantageous in, for example, a portable device that could be used in multiple orientations with respect to gravity.

The intake air, now having been separated from much of its previously held water vapor by mechanical condenser 172, will then be directed through coalescing filter 174, which comprises a narrowly-spaced field of glass fibers such as, for example, borosilicate glass microfibers, or porous, sintered materials that capture water vapor that still remaining in the intake air while allowing the intake air to continue flowing through. More specifically, as the intake air flows through coalescing filter 174, water particles in the intake air can be captured by three different mechanisms: (1) direct interception as water particles impinge on the fibers; (2) inertial impaction as water particles are thrown against fibers by the turbulent air stream; and (3) diffusion as smaller water particles vibrate and collide with fibers and other particles. As a result, coalescing filter 174 is able to capture water particles smaller than the nominal size of the flow passages through the element, and the captured water particles migrate to the crossing points of the fibers where larger water droplets form or coalesce. These formed water droplets, now separated from the intake air and blocked from flowing past coalescing filter 174 through sieve bed 140, eventually grow large enough for gravitational forces to cause the droplets to drop from the filter field and then directed by air baffle 180 into water sump zone 182 where they gather or collect.

In this fashion, during the adsorbing portion of each cycle of sieve bed 140, as humid, pressurized intake air enters at first end 158 of casing 156, mechanical separator 170 can substantially remove water vapor in the air to ensure that the sieve material 162 is exposed to relatively dry air, thereby substantially reducing the risk of damaging the sieve material. The water vapor that is removed from the intake air is collected in water sump zone 182, which includes a drain valve 188 that opens to air purge path 186. During the purging portion of each cycle of sieve bed 140, drain valve 188 is opened, and the collected water in water sump zone can be discharged along with nitrogen being purged from sieve material 162 during the purge process inherent in the PSA cycle. For example, in the present exemplary embodiment, the larger stream of concentrated oxygen that is diverted through pressure reducing orifice 152 to flow through the sieve bed is further pneumatically diverted through air purge path 186 such that it flows through a low gravitational point within water sump zone 182, thereby effectively evacuating the collected water by blowing or venting it to ambient atmospheric pressure along with the nitrogen that is dissipating from sieve material 162 as it is being regenerated. Thus, the water that is separated from the intake air is dispelled from concentrator 114 using, for example, a pressure change or a vacuum generator, and exits system 100 along with the nitrogen being purged.

It should be appreciated that exemplary embodiments of the present invention are not limited by the above-described exemplary embodiment. Any water separating mechanism that can be integrated within a gas concentrating apparatus and encompasses the general concept of forming an integrated gas flow path having a lower gravitational region or sump zone configured such that intake gas flows past the sump zone, and water vapor in the intake gas collects in the sump zone and is discharged, along with exhaust gas during the normal purge cycle of the gas concentrating apparatus, through an air purge path that is integrated with the sump zone is contemplated to be within the scope of the present invention.

Accordingly, exemplary embodiments of the present invention can be implemented to provide a cost-effective design for removing water vapor from the pressurized intake air of an sieve bed employed in an oxygen concentrator. Exemplary embodiments can thereby improve performance and reliability of oxygen concentration system in high humidity environments. Exemplary embodiments utilize a design for separating water from intake air that does not necessitate the packaging of additional zeolite or other sieve material, does not call for the use of any additional or supplemental desiccant material, that is regenerative, and that does not require periodic replacement. Exemplary embodiments can be implemented to provide for a lightweight and small volume oxygen concentration system.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An apparatus for separating humidity from a pressurized feed gas, the apparatus comprising:
a housing having a first end, a second end, and an inner wall;
an intake path formed at the first end of the housing for delivering the feed gas into the housing during a charge phase, the feed gas comprising a product gas, an exhaust gas, and water vapor;
a centrifugal device disposed within the housing proximate to the intake path, the centrifugal device being positioned to receive the feed gas from the intake path during the charge phase and being configured to direct the feed gas toward an inner wall of the housing in a centrifugal pattern to cause the water vapor in the feed gas to separate from the feed gas and condense into water droplets on the inner wall, the centrifugal device being further configured to pass the feed gas in a first direction from the first end of the housing toward the second end;
a sieve bed disposed within the housing between the first end and the second end, the sieve bed comprising an adsorbent material for separating the exhaust gas in the feed gas from the product gas, the sieve bed being configured to receive the feed gas passed from the centrifugal device during the charge phase, to adsorb the exhaust gas from the feed gas, and to pass the product gas from the feed gas in the first direction toward the second end;
an outlet path formed at the second end of the housing, the outlet path being configured to receive the product gas from the sieve bed and to deliver the product gas out of the housing during the charge phase, the outlet path being further configured to deliver the product gas into the housing and to pass the product gas in a second direction from the second end of the housing toward the first end during a purge phase, the sieve bed being further configured to receive the product gas from the outlet path and to pass the product gas in the second direction toward the second end during the purge phase, the product gas acting to evacuate the exhaust gas adsorbed by the sieve bed as it flows through the sieve bed in the second direction during the purge phase;
a purge path formed at the first end of the housing below the intake path, the purge path being configured to receive the product gas and the exhaust gas flowing in the second direction from the sieve bed and discharge the product gas and the exhaust gas from the housing during the purge phase; and
a water sump zone located within the housing below the centrifugal device, the water sump zone being configured to collect the water droplets condensed against the inner wall, the water sump zone being in fluid communication with the purge path such that the water droplets in the water sump zone are discharged from the housing through the purge path with the exhaust gas and the product gas during the purge phase,
wherein the housing is configured to alternately receive the feed gas through the intake path during the charge phase and discharge the exhaust gas through the purge path during the purge phase for charge/purge durations.

2. The apparatus of claim 1, further comprising a filter disposed within the housing between the centrifugal device and the sieve bed, the filter including a network of fibers, the filter being configured to receive the feed gas from the centrifugal device and to cause the water vapor in the feed gas to coalesce into water droplets within the network of fibers during the charge phase, the filter being further configured to pass the feed gas in the first direction from the centrifugal device toward the sieve bed, and wherein the water sump zone is configured to collect the water droplets coalesced within the network of fibers as the water droplets are drawn into the water sump zone by gravitational forces.

3. The apparatus of claim 2, wherein the network of fibers comprises glass fibers or porous, sintered materials.

4. The apparatus of claim 2, further comprising a diffuser plate disposed within the housing between the filter and the sieve bed, the diffuser plate including a plurality of pores permitting flow therethrough.

5. The apparatus of claim 1, wherein the water droplets condensed against the inner wall are drawn into the water sump zone by gravitational forces.

6. The apparatus of claim 1, wherein the inner wall of the housing includes a plurality of grooves configured to direct the water droplets condensed against the inner wall toward the water sump zone.

7. The apparatus of claim 1, wherein the purge path is positioned such that water droplets collected in the water sump zone are drawn toward the purge path by gravitational forces.

8. The apparatus of claim 1, wherein the centrifugal device comprises an air deflector configured to direct the feed gas in the centrifugal pattern and an air baffle, the air baffle being configured to direct the water droplets condensed against the inner wall toward the water sump zone and substantially restrict flow of the feed gas toward the water sump zone during the charge phase.

9. The apparatus of claim 1, wherein the feed gas comprises pressurized ambient air, the product gas comprises oxygen, and the exhaust gas comprises nitrogen, and wherein the adsorbent material is capable of adsorbing nitrogen from pressurized ambient air.

10. A gas concentration apparatus, comprising:
a first housing having a first end, a second end, and an inner wall, the first housing being configured to alternately receive a feed gas from a first intake path formed at the first end of the first housing during a charge phase and to discharge an exhaust gas through a first purge path formed at the first end of the first housing below the first intake path during a purge phase, the feed gas comprising a product gas, the exhaust gas, and water vapor;
a first centrifugal device disposed within the first housing proximate to the first intake path, the first centrifugal device being positioned to receive the feed gas from the first intake path during the charge phase and being configured to direct the feed gas toward an inner wall of the first housing in a centrifugal pattern to cause the water vapor in the feed gas to separate from the feed gas and to condense into water droplets on the inner wall of the first housing, the first centrifugal device being further configured to pass the feed gas in a first direction from the first end of the first housing toward the second end of the first housing;
a first sieve bed disposed within the first housing between the first second ends of the first housing, the first sieve bed comprising an adsorbent material for separating the exhaust gas in the feed gas from the product gas, the first sieve bed being configured to receive the feed gas passed from the first centrifugal device during the charge phase, to adsorb the exhaust gas from the feed gas, and to pass the product gas from the feed gas in the first direction toward the second end of the first housing;
a first outlet path formed at the second end of the first housing, the first outlet path being configured to receive the product gas from the first sieve bed and to deliver the product gas out of the first housing during the charge phase, the first outlet path being further configured to deliver the product gas into the first housing and to pass the product gas in a second direction from the second end of the first housing toward the first end during the purge phase, the first sieve bed being configured to receive the product gas from the first outlet path and to pass the product gas in the second direction toward the second end of the housing during the purge phase, the product gas acting to evacuate the exhaust gas adsorbed by the first sieve bed as it flows through the first sieve bed in the second direction during the purge phase, the first purge path being configured to receive the product gas and the exhaust gas flowing in the second direction from the first sieve bed and to discharge the product gas and the exhaust gas from the first housing during the purge phase;
a first water sump zone located within the first housing below the first centrifugal device, the first water sump zone being configured to collect the water droplets condensed against the inner wall of the first housing, the first water sump zone being in fluid communication with the first purge path such that the water droplets in the first water sump zone are discharged from the first housing through the first purge path with the exhaust gas and the product gas during the purge phase;
a second housing having a first end, a second end, and an inner wall, the second housing being configured to alternately receive the feed gas from a second intake path formed at the first end of the second housing during a charge phase and to discharge an exhaust gas through a second purge path formed at the first end of the second housing below the second intake path during a purge phase;
a second centrifugal device disposed within the second housing proximate to the second intake path, the second centrifugal device being positioned to receive the feed gas from the second intake path during the charge phase and being configured to direct the feed gas toward an inner wall of the second housing in a centrifugal pattern to cause the water vapor in the feed gas to separate from the feed gas and to condense into water droplets on the inner wall of the second housing, the second centrifugal device being further configured to pass the feed gas in a third direction from the first end of the second housing toward the second end;
a second sieve bed disposed within the second housing between the first and second ends of the second housing, the second sieve bed comprising the adsorbent material for separating the exhaust gas in the feed gas from the product gas, the second sieve bed being configured to receive the feed gas passed from the second centrifugal device during the charge phase, to adsorb the exhaust gas from the feed gas, and to pass the product gas from the feed gas in the third direction toward the second end of the second housing;
a second outlet path formed at the second end of the second housing, the second outlet path being configured to receive the product gas from the second sieve bed and to deliver the product gas out of the second housing during the charge phase, the second outlet path being further configured to deliver the product gas into the second housing and to pass the product gas in a fourth direction from the second end of the second housing toward the first end during the purge phase, the second sieve bed being configured to receive the product gas from the second outlet path and to pass the product gas in the fourth direction toward the second end of the second housing during the purge phase, the product gas acting to evacuate the exhaust gas adsorbed by the second sieve bed as it flows through the second sieve bed in the fourth direction during the purge phase, the second purge path being configured to receive the product gas and the exhaust gas flowing in the fourth direction from the second sieve bed and to discharge the product gas and the exhaust gas from the second housing during the purge phase;
a second water sump zone located within the second housing below the second centrifugal device, the second water sump zone being configured to collect the water droplets condensed against the inner wall of the second housing, the second water sump zone being in fluid communication with the second purge path such that the water droplets in the second water sump zone are discharged from the second housing through the second purge path with the exhaust gas and the product gas during the purge phase;
a compressor configured to receive the feed gas and supply the feed gas under pressure to the first and second intake paths;
a set of valves disposed between the compressor and the first ends of the first and second housings; and
a controller coupled to the set of valves and configured to selectively open and close the valves to alternately charge the first housing with the feed gas while the exhaust gas is purged from the second housing and charge the second housing with the feed gas while the exhaust gas is purged from the second housing for the charge/purge durations.

11. The apparatus of claim 10, wherein the water droplets condensed against the inner wall of the first housing are drawn into the first water sump zone by gravitational forces, and wherein the water droplets condensed against the inner wall of the second housing are drawn into the second water sump zone by gravitational forces.

12. The apparatus of claim 10, wherein the first housing further comprises a filter disposed within the first housing between the first centrifugal device and the first sieve bed, the filter including a network of fibers, the filter being configured to receive the feed gas from the first centrifugal device and to cause the water vapor in the feed gas to coalesce into water droplets within the network of fibers during the charge phase, the filter being further configured to pass the feed gas in the first direction from the first centrifugal device toward the first sieve bed, and wherein the first water sump zone is configured to collect the water droplets coalesced within the network of fibers as the water droplets are drawn into the first water sump zone by gravitational forces.

13. The apparatus of claim 10, further comprising a vacuum generator in fluid communication with the first and second purge paths, and wherein the controller is configured to compel the vacuum generator to alternate drawing the exhaust gas adsorbed by the first sieve bed and the water droplets collected in the first water sump zone through the first purge path to discharge exhaust gas and water droplets from the first sieve bed and drawing the exhaust gas adsorbed by the second sieve bed and the water droplets collected in the second water sump zone through the second purge path to discharge exhaust gas and water droplets from the second housing.

14. The apparatus of claim 10, wherein the adsorbent material of the first and second sieve beds comprises small pores of zeolite material configured to adsorb nitrogen from pressurized ambient air.

15. The apparatus of claim 14, wherein the apparatus is configured to receive ambient air and produce a supply of concentrated oxygen by implementing a process selected from pressure swing adsorption (PSA), vacuum pressure swing adsorption (VPSA), a rapid PSA process, or a very rapid PSA process.

16. The apparatus of claim 15, further comprising an energy source, a control unit, and one or more output sensors for sensing one or more conditions of a user or of an environment, and wherein the control unit is configured to regulate the supply of concentrated oxygen to the user in response to the one or more conditions sensed by the sensor.

17. The apparatus of claim 10, wherein the first housing further comprises a first diffuser plate disposed proximate to the first end of the first housing and a second diffuser plate disposed proximate to the second end of the first housing, each diffuser plate including a plurality of pores permitting flow therethrough, the diffuser plates being configured to retain the adsorbent material of the first sieve bed therebetween.

18. A method for separating water particles from a pressurized gas mixture, the method comprising:
receiving a feed gas from an intake path of a housing for a sieve bed, the feed gas comprising a product gas, an exhaust gas, and water vapor, the sieve bed comprising an adsorbent material for separating the exhaust gas in the feed gas from the product gas;
directing the feed gas to move in a centrifugal pattern such that the water vapor in the feed gas is forced radially outward against an inner wall of the housing;
permitting the water vapor forced against the inner wall to condense into water droplets;
directing the feed gas through the sieve bed such that the adsorbent material adsorbs the exhaust gas in the feed gas;
collecting the water droplets condensed against the inner wall in a water sump zone located within the housing; and
discharging the exhaust gas adsorbed by the absorbent material and water droplets collected in the water sump zone from the housing through a purge path.

19. The method of claim 18, further comprising directing the feed gas toward a coalescing filter having a network of fibers to cause the water vapor in the pressurized gas mixture to coalesce into water droplets within the network of fibers, and collecting the water droplets coalesced within the network of fibers in the water sump zone as the water droplets are drawn into the water sump zone by gravitational forces.
